(19) United States
(12) Patent Application Publication
(10) Pub. No.: US 2026/0190181 A1
(43) Pub. Date: Jul. 2, 2026

(54) METHOD AND APPARATUS FOR USING RADIO RESOURCES DURING EMERGENCY SESSION IN COMMUNICATION SYSTEM

(71) Applicant: SAMSUNG ELECTRONICS CO., LTD., Suwon-si, Gyeonggi-do (KR)

(72) Inventors: Chadi KHIRALLAH, Staines, Middlesex (GB); Mahmoud WATFA, Staines, Middlesex (GB)

(21) Appl. No.: 19/130,335

(22) PCT Filed: Nov. 16, 2023
(86) PCT No.: PCT/KR2023/018406

§ 371 Date: May 15, 2025

(30) Foreign Application Priority Data
Nov. 16, 2022 (GB) 2217096.3
Oct. 6, 2023 (GB) 2315391.9

(51) Int. Cl. H04W 76/50; H04W 4/90; H04W 48/18

(52) U.S. Cl. CPC H04W 76/50; H04W 4/90; H04W 48/18

(57) ABSTRACT

The disclosure relates to a 5G or 6G communication system for supporting a higher data transmission rate. According to one embodiment of the disclosure, a method performed by a non-access stratum (NAS) layer of a terminal in a wireless communication system, the method comprising: identifying at least one information on network slice related to an access attempt; and transmitting, to a lower layer of the terminal, the at least one information on the network slice related to the access attempt, wherein the at least one information on the network slice is included in at least one of information on uplink data status, information on allowed packet data unit (PDU) session status, or a message for a PDU session associated with the network slice.

### TECHNICAL FIELD

The present invention relates to improvements in network slicing in a telecommunication network. It applies particularly, but not exclusively, to Fifth Generation, 5G, networks, but has wider application.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### DISCLOSURE OF INVENTION

### Technical Problem

In line with development of the communication systems, there is a need for method and apparatus for using radio resources during emergency session in communication system.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

Disclosed is a method of operating a User Equipment, UE, arranged for communication with a telecommunication network, comprising the steps of: a Non-Access Stratum, NAS, layer in the UE identifies a slice, identified by a Single Network Slice Selection Assistance Information, N-SSAI, for which an access attempt is made via a NAS message; wherein the step of identifying the slice is based on one of: a slice that corresponds to a PDU session, indicated by an Uplink data status Information Element, IE, which is included in the NAS message; a slice that corresponds to a PDU session, indicated by an Allowed PDU session status IE, which is included in the NAS message; or a 5GSM procedure.

Embodiments disclosed herein provide a method for using radio resources during emergency session. Embodiments disclosed herein provide a method performed by a non access stratum (NAS) layer of a terminal in a wireless communication system, the method comprising: identifying at least one information on network slice related to an access attempt; and transmitting, to a lower layer of the terminal, the at least one information on the network slice related to the access attempt; wherein the at least one information on the network slice is included in at least one of information on uplink data status, information on allowed packet data unit (PDU) session status, or a message for a PDU session associated with the network slice.

Embodiments disclosed herein provide a method performed by a terminal in a wireless communication system, the method comprising: identifying at least one information on network slice related to an access attempt; and transmitting, from a non access stratum (NAS) layer of the terminal to a lower layer of the terminal, the at least one information on the network slice related to the access attempt; wherein the at least one information on the network slice is included in at least one of information on uplink data status, information on allowed packet data unit (PDU) session status, or a message for a PDU session associated with the network slice.

Embodiments disclosed herein provide a terminal in a wireless communication system, the terminal comprising: a transceiver; and at least one processor coupled with the transceiver and configured to: identify at least one information on network slice related to an access attempt, and transmit, from a non access stratum (NAS) layer of the terminal to a lower layer of the terminal, the at least one information on the network slice related to the access attempt, wherein the at least one information on the network slice is included in at least one of information on uplink data status, information on allowed packet data unit (PDU) session status, or a message for a PDU associated with the network slice.

### Advantageous Effects of Invention

The present disclosure provides an effective and efficient method for using radio resources during emergency session in communication system.

Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

FIG. 1 is a sequence diagram illustrating an embodiment of the invention.

### MODE FOR THE INVENTION

Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

A set of slices, (each slice identified as Single Network Slice Selection Assistance Information S-NSSAI) may be known to be part of a group—Network Slice Access Group, NSAG—where the set of slices may be optionally valid with a set of Tracking Area Identities, TAIs, if available, and a certain priority level may also be associated with these slices-and hence the group. If the list of TAIs is not available, then the slices are valid in the entire Public Land Mobile Network, PLMN. The following is an excerpt from section 4.6.2.6 of 3GPP TS 24.501 regarding NSAG:
“NSAG information provided by the network and stored in the UE includes a list of NSAGs each of which contains:
a) an NSAG ID;
b) a list of S-NSSAI(s), which are associated with the NSAG and shall be part of the configured NSSAI;
c) optionally a list of TAIs in which the NSAG is valid. If it is not provided by the network, the NSAG is valid in the PLMN which has sent the NSAG information; and
d) a priority value that is associated with the NSAG.

The UE NAS layer shall provide the lower layers with the most recent NSAG information stored in the UE (see subclause 4.6.2.2) to lower layers.
NOTE: Along with the NSAG information, the UE provides to the lower layers with allowed NSSAI and requested NSSAI for the purpose of NSAG-aware cell reselection.”

The UE lower layers use the NSAG information for cell reselection or for accessing a cell (e.g. Random Access via Random Access Channel-RACH).

The following is from Section 16.3.1 in 3GPP TS 38.300 (V 17.2.0) on this topic:

### Slice Availability

Some slices may be available only in part of the network. The NG-RAN supported S-NSSAI(s), NSAG(s) and NSAG related information such as NSAG associated Cell Reselection Priority are configured by OAM. Awareness in the NG-RAN of the slices supported in the cells of its neighbours may be beneficial for inter-frequency mobility in connected mode. It is assumed that the slice availability does not change within the UE's registration area (see TS 23.501[3 ]).
The NG-RAN and the 5GC are responsible to handle a service request for a slice that may or may not be available in a given area. Admission or rejection of access to a slice may depend by factors such as support for the slice, availability of resources, support of the requested service by NG-RAN.”

The following is from section 16.3.3a on this topic:
“16.3.3a Slice-based cell reselection

Slice-based cell reselection information can be included in SIB 16 and in RRCRelease messages. The slice-based cell reselection information may include reselection priorities per NSAG per frequency and corresponding list(s) of cells where the slices of the NSAG are supported or not supported. In the UE, NAS provides the NSAG(s) and their priorities to be considered during cell reselection. In order to support the NSAG, the NG-RAN provides the AMF with the NSAG information per TA in the appropriate NG interface management procedures, as specified in TS 23.501[3 ]. Awareness in the NG-RAN of the NSAG information supported in the list(s) of neighbour cells may be configured by OAM, or exchanged with neighbour NG-RAN nodes.

When a UE supports slice-based cell reselection, and when slice-based cell reselection information is provided to the UE, then the UE uses the slice-based cell reselection information. Valid cell reselection information provided in RRCRelease always has a priority over cell reselection information provided in SIB messages. When no slice-based reselection information is provided for any NSAG that UE AS received from NAS to be considered during cell reselection, then the UE uses the general cell reselection information, i.e., without considering the NSAG(s) and their priorities.”

From the above, it can be seen that the UE uses slice-based cell reselection based on the information in the UE.

The following is indicated in section 9.2.6 in 3GPP TS 38.300 (V 17.2.0):
“The network can associate a set of RACH resources with feature(s) applicable to a Random Access procedure: Network Slicing (see clause 16.3), RedCap (see clause 16.13), SDT (see clause 18), and NR coverage enhancement (see clause 19). A set of RACH resources associated with a feature is only valid for random access procedures applicable to at least that feature; and a set of RACH resources associated with several features is only valid for random access procedures having at least all of these features. The UE selects the set(s) of applicable RACH resources, after uplink carrier (i.e. NUL or SUL) and BWP selection and before selecting the RA type.”

From the above, it can be seen that the UE uses a set of RACH resources which are applicable to network slicing i.e. for NSAG.

A problem in the prior art arises when UE behaviour can be unclear with respect to which resources will be used when there is an access attempt for an emergency PDU session.

The NSAG feature uses specific resources for a set of slices (or S-NSSAIs) when the UE attempts access for the slices in the NSAG.

The UE may attempt to establish a PDU session for emergency and hence the UE's access attempt is for emergency. However, there is no slice (i.e. S-NSSAI) which is known to the UE to be a slice for emergency. This is because the slice for emergency is selected by the Access and Mobility Management Function, AMF, of the network, if any.

This leads to one or more of the following problems:
Given a certain set of slices that are chosen to be used e.g. based on the current allowed NSSAI or current chosen NSAG information, when the UE needs to place an emergency call, how can the UE know which resources to use given that the slice for an emergency call is never part of the NSAG information?
If the expected UE behaviour is not defined in a standardized way, then different UEs will end up using different resources, where some resources may be inefficient or of lower priority and hence this may cause delays to the establishment of the emergency PDU session

As such, well-defined and standardised UE behaviour is desirable, in order to solve one or more of the problems set out above.

To state the problem another way, there may be one or more different reasons why the Non-Access Stratum, NAS, wants to go to connected mode and therefore the UE may need to use several different slices when it enters connected mode. However, each NAS procedure may be associated with a different slice (S-NSSAI) and so in order for the NSAG feature to work correctly, the lower layers in the UE must use the appropriate radio resources (e.g. RACH) which correspond to the NAS procedure and Information Elements, IE, that the NAS wants to send to the network.

In the prior art, there is no clear description of how the NAS clearly and unambiguously indicates the slices (S-NSSAIs) that the UE wants to use when it enters into connected mode. Without this explicit description, the lower layers may use the wrong resources (e.g. for RACH) which may be of lower priority and hence can cause significant delay to the service. This can lead to undefined behaviour and consequent negative user experience.

According to the present invention there is provided an apparatus and method as set forth in the appended claims. Other features of the invention will be apparent from the dependent claims, and the description which follows.

According to a first aspect of the present invention, there is provided a method of operating a User Equipment, UE, arranged for communication with a telecommunication network, comprising the steps of:
a Non-Access Stratum, NAS, layer in the UE identifies a slice, identified by a Single Network Slice Selection Assistance Information, N-SSAI, for which an access attempt is made via a NAS message;
wherein the step of identifying the slice is based on one of:
   a slice that corresponds to a PDU session, indicated by an Uplink data status Information Element, IE, which is included in the NAS message;
   a slice that corresponds to a PDU session, indicated by an Allowed PDU session status IE, which is included in the NAS message; or
   a 5GSM procedure.

In an embodiment, the identified slice is provided from the NAS layer to a lower layer of the UE.

In an embodiment, the UE is in 5GMM-IDLE mode or in 5GMM-CONNECTED mode with RRC inactive indication.

In an embodiment, if the access attempt is related to an emergency service, then the NAS layer does not provide any slice information to a lower layer.

In an embodiment, the 5GSM procedure is one of a PDU session modification procedure, a PDU session establishment procedure or a PDU session release procedure.

According to a second aspect of the present invention, there is provided a method of operating a User Equipment, UE, arranged for communication with a telecommunication network, wherein if an attempt is made to access the telecommunication network for emergency service, then a NAS layer in the UE does not pass any slice information to a lower layer.

In an embodiment, the step of the UE not passing any slice information to the lower layer is either because the UE determines that there is no such slice information or that no such slice information should be passed.

According to a third aspect of the present invention, there is provided apparatus arranged to perform the method of any preceding aspect.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

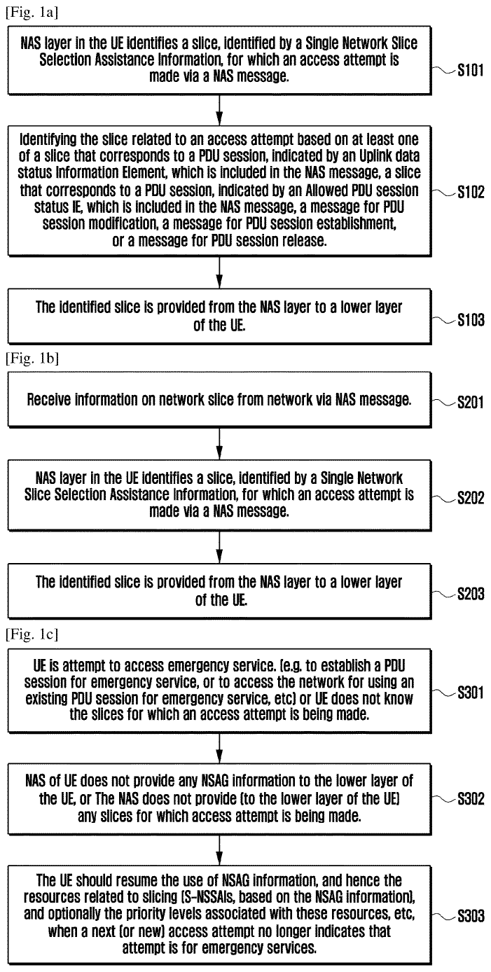

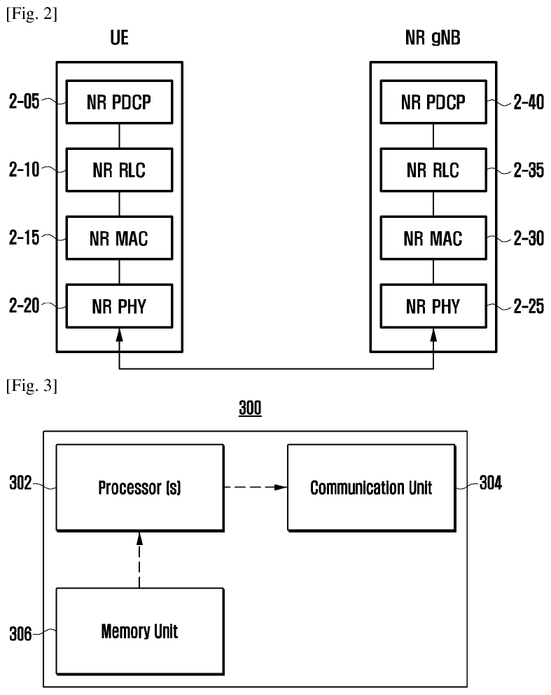

FIG. 1 shows a flowchart illustrating an embodiment of the present invention.

An embodiment of the invention aims to define how the UE uses resources when there is a need to place an emergency PDU session, given that the UE is already using NSAG information.

Note that throughout this specification the term “UE” may be referring to any layer or entity in the UE e.g. the NAS layer, or RRC layer or both or multiple layers or entities. As such, any detail provided herein may apply to any of these layers or entities in any combination or order, or may apply to more than one layer or entity.

When the UE determines that there is an access attempt for emergency services (e.g. to establish a PDU session for emergency service, or to access the network for using an existing PDU session for emergency service, etc), then the UE should take any of the following actions in any order or combination:
The UE (e.g. RRC) should stop using any specific resources that were otherwise being used (e.g. for NSAG or slice specific random access or cell reselection) before this access attempt or before the emergency request is sent (e.g. before the PDU session for emergency services is established)
The UE (e.g. RRC) should use the resources related to the highest priority of the NSAG information
The UE randomly picks an NSAG and uses the priority and/or resources associated with the randomly picked NSAG

Note that the UE (e.g. RRC) may determine that the access attempt is for emergency based on the established cause received from the NAS (e.g. indicating emergency) or based on a specific access category value as defined in 3GPP TS 24.501 e.g. value number 2, or based on any other method that points to an emergency session.

The UE (e.g. RRC) should resume the use of NSAG information, and hence th resources related to slicing (S-NSSAIs, based on the NSAG information), and optionally the priority levels associated with these resources, etc, when a next (or new) access attempt no longer indicates that the attempt is for emergency services. Note that the UE resuming the use of NSAG information means that the UE does not use the general cell reselection information or the general cell random access resources, but rather the UE would/should use the resources that are associated with the slices in the NSAG or that are associated with the NSAG information. Alternatively, the UE resumes the use of NSAG information (e.g. resources associated with certain slices, or NSAG, or priority, etc) when the PDU session is released or when the user plane resources for the emergency PDU session have been released.

In another embodiment, the UE behaves as described above when the UE (e.g. RRC layer) does not know the slices for which an access attempt is being made. For example, the UE (e.g. RRC) behaves as described above when the UE (e.g. RRC) does not receive the slices for which an access attempt is being made or does not receive the NSAG priority information (and/or does not receive any NSAG information). In this case, the UE (e.g. RRC) may then use the general resources which are not specific to any NSAG or slicing information or priority or slicing resources, etc. While doing so, the UE may continue to save the NSAG information that was previously received e.g. until a new version or updated version is received.

The RRC may behave as described above optionally when the RRC received NSAG information but does not receive the slices for which the access attempt is being made. In this case, the RRC may use the general resources for random access or for cell reselection or for both.

The UE (e.g. RRC) may switch between using NSAG information (e.g. resources for specific slices, etc) and using general resources (e.g. resources not related to specific slices) based on any one or more of the following:
Whether or not the UE knows the slices for which the access attempt is being made. For example, if the slices for which the access attempt is being made are unknown, then the UE uses the general resources of the cell
For example, if the UE knows the slices for which the access attempt is being made, and the UE optionally has NSAG information which matches the slices for which the access attempt is being made, then the UE uses the resources for the slices for which the access is being made (e.g. based on the NSAG information).

Note that if the NAS layer does not know the slices for which an access attempt is being made, then the NAS layer may take any one or more of the following actions in any order or combination:
When initiating an access attempt, e.g. the UE needs to transition to connected mode (e.g. to 5GMM-CONNECTED mode, optionally from any mode or state), then the NAS does not provide the NSAG information to the RRC layer. Optionally the NAS provides the NSAG information to the RRC layer but does not indicate the slices for which the access attempt in being made, and optionally the NAS may not provide any NSAG priority information. In one alternative, the NAS may provide an NSAG and/or an NSAG priority but no slice for which an access attempt is being made
The NAS layer selects a particular NSAG based on a certain preconfigured manner e.g. the NSAG with the highest priority is selected, the UE selects the NSAG with the lowest priority, or the UE selects a particular NSAG which is known to be associated with no slices, or the UE selects a particular NSAG randomly. The UE may provide the NSAG information and optionally indicate the slices corresponding to the selected NSAG as the slices for which the access attempt is being made. Alternatively, the UE does not provide the slices for which access attempt is being made (since they are not known) but rather provides the NSAG priority and/or the selected NSAG (and may provide the NSAG information as well)
If the lower layers e.g RRC, receive NSAG information and a particular NSAG priority and/or the selected NSAG, then the RRC may consider the selected NSAG as the NSAG that matches the received priority and/or that matches the received NSAG (optionally in addition to the NSAG priority). Once the RRC determines the selected NSAG and/or the selected NSAG priority, then the RRC uses the resources that are associated with this determined selected NSAG and/or NSAG priority.

Note that the NAS may consider that the slice for which an access attempt is being made is unknown (or the NAS may determine that the slice for which the access being made is unknown) either when: the UE is trying to establish a PDU session for emergency services, or the UE is trying to access the network and use an existing PDU session for emergency PDU session, or the UE is attempting to establish a PDU session but does not know which slice to use for the session.

Alternatively, for an existing PDU session which the UE may have established without including a slices (e.g. without sending an S-NSSAI), the UE may determine (and optionally use) the slice for which an access attempt is being as follows:
The slice (or S-NSSAI) is the S-NSSAI that the UE has received in the PDU session establishment accept message, optionally even if the session is for emergency, or optionally if the session is not for emergency, and optionally if the UE did not send any slice (or any S-NSSAI) when the session was established (or when the UE sent the PDU session establishment request message)

However, when the UE determines that the slice, for which an access attempt is being made, is unknown (i.e. the UE is not able to determine the slice for which an access attempt is being made), then the UE behaves as described above/herein. E.g. the NAS does not indicate (e.g. to the RRC) any slice for which the access attempt is being made, or the RRC does not use any slice specific resources (based on NSAG information) but rather uses the general resources of the cell or network or RAN.

As such, when the NAS considers or determines that the slices for which an access attempt is being made are not known, or when the NAS determines that there are no slices for which the access attempt is being made (or when the NAS is not able to determine the slices for which an access attempt is being made), then the NAS may behave as described earlier, e.g.:
The NAS does not provide any NSAG information to the RRC
The NAS does not provide (to the RRC) any slices for which access attempt is being made, or the NAS indicates to the RRC that there are no slices for which the access attempt is being made. The NAS may optionally provide NSAG information or NSAG or NSAG priority e.g. based on a selection that the NAS makes as proposed earlier.

If the UE is able to determine at least one slice for which the access attempt is being made (e.g. due to a request associated with a known slice, or to use/request resources for an existing PDU session for which the slice was optionally requested/provided by the UE at the time of the establishment) but also cannot determine at least one other slice for which the same access is being made (e.g. where the pending procedure is for an emergency service or for any PDU session for which the UE cannot determine or does not include a slice), then the UE may behave in any of the following manners:
Since one slice is not known, the UE may conclude that no slice can be determined for the current access and hence may behave as described earlier. In one option, the UE may behave as described if the slice which is not known is related to a PDU session for emergency services. E.g. in this case, the NAS does not provide (to the RRC) the slices for which the access attempt is being made. The NAS may provide NSAG information or priority, etc if available. The RRC may behave as described earlier e.g. the RRC would use general resources if it does not receive slices for which the access attempt is being made
Since at least one slice is known, and optionally at least one other slice is not known, the UE may consider the known slices as the slices for which the access attempt is being made. The NAS provides that information to the lower layers (e.g. RRC) and optionally includes the NSAG information or priority, etc.

In some cases, the UE gets paged and then the UE sends a NAS message (e.g. Service Request or Registration Request) with the Uplink data status IE and/or the Allowed PDU session status IE. The following describes a proposal that enables the UE to determine the slices for which the access attempt is being made:
The S-NSSAIs for which an access attempt is being made is the S-NSSAI which corresponds to each PDU session for which the UE requests the establishment of user plane resources by means of the Uplink data status IE (where optionally the UE intends to include or includes this IE in the NAS message). For example, a slice (or S-NSSAI) is determined to be a slice for which an access attempt is being made if the slice corresponds to a PDU session (identified by a PDU session ID) for which the UE sets the bit position to 1 in the Uplink data status IE, where the value 1 indicates e.g. “indicates that uplink data are pending for the corresponding PDU session identity and the user-plane resources for the corresponding PDU session are not established”. As such, if a bit position for a PDU session (identified by a PDU session ID) is set to the value 0, or is not set to the value 1, then the slice corresponding to this PDU session is not a slice for which an access attempt is being made
The S-NSSAIs for which an access attempt is being made is the S-NSSAI which corresponds to each PDU session for which the UE requests the establishment of user plane resources (or for which the UE requests to be transferred from non-3GPP access to 3GPP access) by means of the Allowed PDU session status IE (where optionally the UE intends to include or includes this IE in the NAS message). For example, a slice (or S-NSSAI) is determined to be a slice for which an access attempt is being made if the slice corresponds to a PDU session (identified by a PDU session ID) for which the UE sets the bit position to 1 in the Allowed PDU data status IE, where the value 1 indicates e.g. “indicates that the user-plane resources of corresponding PDU session can be re-established over 3GPP access”. As such, if a bit position for a PDU session (identified by a PDU session ID) is set to the value 0, or is not set to the value 1, then the slice corresponding to this PDU session is not a slice for which an access attempt is being made
Any S-NSSAI for which the UE intends to establish a PDU session, or for which there is a pending NAS procedure (e.g. PDU session modification procedure or PDU session establishment procedure or PDU session release procedure).
Any combination of the above

In one alternative, if the UE is accessing the network to release at least one PDU session, then the UE may behave as if the slice for which the access attempt in being made is not known.

In one alternative, if the UE needs to establish a PDU session but does not know the slice that should be used with the request (e.g. with the PDU session establishment request message), and if the UE only has one S-NSSAI in the allowed NSSAI, then the UE determines that the slice for which the access attempt is being made is the (only) S-NSSAI which is part of the allowed NSSAI.

In one alternative, if the UE has no S-NSSAI in the allowed NSSAI, and the UE has a pending NSSAI (which is not empty), then when responding to paging, the UE considers that the slice for which the access attempt is being made is not known i.e. the UE determines that there is no identified S-NSSAI for which the access attempt is being made. As such, the UE behaves as described earlier e.g. the NAS does not provide, to the lower layers (e.g. RRC), the slice for which an access attempt is being made, or the RRC does not use resources related to NSAG information, etc.
Note: once the UE knows the slices for which the access is attempt is being made, then the UE provides this information to the lower layers when the UE is using NSAG information.

Note that in one alternative, the network may send to the UE e.g. as part of the NSAG information, an NSAG (i.e. a network slice access group) which contains no S-NSSAI and may contain a priority level. As such, anytime the UE needs to establish a PDU session, or perform an access to the network, such that the slice (for which the access is being made) is not known, then the UE uses the associated NSAG and/or NSAG priority and provides it to the lower layers. The lower layers e.g. RRC, may use it as described herein for the case when the slice for which the access is being made) is not known. E.g. the RRC uses general resources in this cases, or the resources corresponding to the received priority or NSAG (although no particular S-NSSAI may have been received).
Note: NSAG information may refer to a set of: network slice access group (NSAG), and/or a priority level, and/or a list of TAI where the information is valid, or any combination of these.
Note: NSAG may refer to the group that is associated with a set of slices (where the set of slices may be empty) Note: priority level, or NSAG priority, may refer to a priority associated with the NSAG

The details presented above can be applied in any order or combination, and may apply for a UE which is in 5GMM-IDLE mode or 5GMM-CONNECTED mode with RRC inactive indication, or for a UE which is trying to transition from these modes/states to the 5GMM-CONNECTED mode.

FIG. 1 shows a representation of an embodiment of the present invention.

At S101, a Non-Access Stratum, NAS, layer in the UE identifies a slice, identified by a Single Network Slice Selection Assistance Information, N-SSAI, for which an access attempt is made via a NAS message.

At S102, the step of identifying the slice is based on one of: a slice that corresponds to a PDU session, indicated by an Uplink data status Information Element, IE, which is included in the NAS message; a slice that corresponds to a PDU session, indicated by an Allowed PDU session status IE, which is included in the NAS message; or a 5GSM procedure.

At S103, optionally, the identified slice is provided from the NAS layer to a lower layer of the UE.

FIG. 1b illustrates an example according to embodiments of the present disclosure.

At S201, UE receives information on network slice (e.g. NASG information) from network via NAS message.

At S202, NAS layer in the UE identifies a slice, identified by a Single Network Slice Selection Assistance Information, for which an access attempt is made via a NAS message. the step of identifying the slice is based on one of: a slice that corresponds to a PDU session, indicated by an Uplink data status Information Element, IE, which is included in the NAS message; a slice that corresponds to a PDU session, indicated by an Allowed PDU session status IE, which is included in the NAS message; or a 5GSM procedure.

At S203, optionally, the identified slice is provided from the NAS layer to a lower layer of the UE.

FIG. 1c illustrates an example according to embodiments of the present disclosure.

At S301, UE is attempt to access emergency service. (e.g. to establish a PDU session for emergency service, or to access the network for using an existing PDU session for emergency service, etc) or UE does not know the slices for which an access attempt is being made.

At S302, NAS of UE does not provide any NSAG information to the lower layer of the UE, or The NAS does not provide (to the lower layer of the UE) any slices for which access attempt is being made.

At S303, The UE should resume the use of NSAG information, and hence the resources related to slicing (S-NSSAIs, based on the NSAG information), and optionally the priority levels associated with these resources, etc, when a next (or new) access attempt no longer indicates that the attempt is for emergency services.

FIG. 2 illustrates a radio protocol architecture of a next generation mobile communication system according to an embodiment of the disclosure.

Referring to FIG. 2, for each of a UE and a NR base station, the radio protocol of the next generation mobile communication system includes NR PDCPs 2-05 and 2-40, NR RLCs 2-10 and 2-35, and NR MACs 2-15 and 2-30. The main functions of the NR PDCPs 2-05 and 2-40 may include some of the following functions:
Header compression and decompression: ROHC only
Transmission of user data
In-sequence delivery of upper layer PDUs
Out-of-order delivery of upper layer PDUs
PDCP PDU reordering for reception
Duplicate detection of lower layer SDUs
Retransmission of PDCP SDUs
Ciphering and deciphering
Timer-based SDU discard in uplink

The reordering function of the NR PDCP device refers to a function of sequentially reordering PDCP PDUs, received from a lower layer based on a PDCP sequence number (SN), and may include a function of transmitting data to an upper layer in the sequence of reordering, a function of transmitting data without considering the sequence, a function of reordering the sequence and recording missing PDCP PDUs, a function of providing a state report on the missing PDCP PDUs to a transmitting side, and a function of requesting retransmission of the missing PDCP PDUs.

The main functions of the NR RLCs 2-10 and 2-35 may include some of the following functions:
Transfer of upper layer PDUs
In-sequence delivery of upper layer PDUs
Out-of-sequence delivery of upper layer PDUs
Error correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of the NR RLC device refers to a function of transmitting RLC SDUs, received from a lower layer, to an upper layer in the sequence of reception, and may include: if one RLC SDU is originally segmented into multiple RLC SDUs and received, a function of reassembling and transmitting the multiple RLC SDUs; a function of reordering the received RLC PDUs based on an RLC sequence number (SN) or PDCP SN; a function of reordering the sequence and recording missing RLC PDUs; a function of providing a state report on the missing RLC PDUs to a transmitting side; and a function of requesting retransmission of the missing RLC PDUs.

The out-of-sequence delivery function of the NR RLC device refers to a function of directly transmitting RLC SDUs, received from a lower layer, to an upper layer regardless of the order, and may include, if one RLC SDU has been originally segmented into multiple RLC SDUs and received, a function of reassembling the multiple RLC SDUs and transmitting the same; and a function of storing the RLC SNs or PDCP SNs of the received RLC PDUs, reordering the sequence, and recording missing RLC PDUs.

The NR MACs 2-15 and 2-30 may be connected to multiple NR RLC layer devices configured in a UE, and the main functions of the NR MAC may include some of the following functions:
Mapping between logical channels and transmission channels
Multiplexing/demultiplexing of MAC SDUs
Scheduling information report
Error correction through HARQ
Priority handling between logical channels of a UE
Priority handling between UEs by means of dynamic scheduling.
MBMS service identification
Transmission format selection
Padding

The NR physical (PHY) layers 2-20 and 2-25 may perform operations of channel coding and modulating upper layer data, generating the upper layer data into an OFDM symbols transmitting the OFDM symbol via a radio channel, or demodulating and channel decoding the OFDM symbol received via the radio channel, and transferring the OFDM symbol to an upper layer.

In the disclosure, a transmitting end device may be a base station or UE and a reception end device may be a base station or UE. That is, the disclosure may include both a case where the transmitting end device is a base station and the reception end device is a UE (downlink data transmission scenario) or a case where the transmitting end device is a UE and the reception end device is a base station (uplink data transmission scenario). FIG. 3 is a diagram illustrating the configuration of a user equipment (UE) 300 in a wireless communication system, according to an embodiment of the present disclosure. The configuration of FIG. 3 may be understood as a part of the configuration of the UE 300. Referring to FIG. 3, the UE 300 may include at least one processor 302, a communication unit 304 (e.g., communicator or communication interface), and a storage unit 306 (e.g., storage). By way of example, the UE 300 may be a User Equipment, such as a cellular phone or other device that communicates over a plurality of cellular networks (such as a 3G, 4G, a 5G or pre-5G, 6G network or any future wireless communication network). The communication unit 304 may perform functions for transmitting and receiving signals via a wireless channel.

As an example, the processor 302 may be a single processing unit or a number of units, all of which could include multiple computing units. The processor 302 may be implemented as one or more microprocessors, microcomputers, microcontrollers, digital signal processors, central processing units, state machines, logic circuitries, and/or any devices that manipulate signals based on operational instructions. Among other capabilities, the processor 302 is configured to fetch and execute computer-readable instructions and data stored in the memory. The processor 302 may include one or a plurality of processors. At this time, one or a plurality of processors 302 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 302 may control the processing of the input data in accordance with a predefined operating rule or artificial intelligence (AI) model stored in the non-volatile memory and the volatile memory, i.e., memory unit 306. The predefined operating rule or artificial intelligence model is provided through training or learning.

The memory 306 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as ap-propriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a non access stratum (NAS) layer of a terminal in a wireless communication system, the method comprising:
identifying at least one information on network slice related to an access attempt; and
transmitting, to a lower layer of the terminal, the at least one information on the network slice related to the access attempt;
wherein the at least one information on the network slice is included in at least one of information on uplink data status, information on allowed packet data unit (PDU) session status, or a message for a PDU session associated with the network slice.

2. The method of claim 1,
wherein the access attempt is made by the terminal in 5GS mobility management (5GMM)-IDLE mode, or 5GMM-CONNECTED mode with radio resource control (RRC) inactive indication.

3. The method of claim 1,
wherein in case that the terminal is attempt to access emergency service, the at least one information on the network slice related to the access attempt is not transmitted to the lower layer of the terminal.

4. The method of claim 1,
wherein the message for the PDU session comprises at least one of a message for PDU session modification, a message for PDU session establishment, or a message for PDU session release.

5. A method performed by a terminal in a wireless communication system, the method comprising:
identifying at least one information on network slice related to an access attempt; and
transmitting, from a non access stratum (NAS) layer of the terminal to a lower layer of the terminal, the at least one information on the network slice related to the access attempt;
wherein the at least one information on the network slice is included in at least one of information on uplink data status, information on allowed packet data unit (PDU) session status, or a message for a PDU session associated with the network slice.

6. The method of claim 5,
wherein the access attempt is made by the terminal in 5GS mobility management (5GMM)-IDLE mode, or 5GMM-CONNECTED mode with radio resource control (RRC) inactive indication.

7. The method of claim 5,
wherein in case that the terminal is attempt to access emergency service, the at least one information on the network slice related to the access attempt is not transmitted to the lower layer of the terminal.

8. The method of claim 5,
wherein the message for the PDU session comprises at least one of a message for PDU session modification, a message for PDU session establishment, or a message for PDU session release.

9. The method of claim 5, further comprising:
based on the at least one information of the network slice related to the access attempt, using resources for the network slice.

10. A terminal in a wireless communication system, the terminal comprising:
a transceiver; and
at least one processor coupled with the transceiver and configured to:
identify at least one information on network slice related to an access attempt, and
transmit, from a non access stratum (NAS) layer of the terminal to a lower layer of the terminal, the at least one information on the network slice related to the access attempt,
wherein the at least one information on the network slice is included in at least one of information on uplink data status, information on allowed packet data unit (PDU) session status, or a message for a PDU associated with the network slice.

11. The terminal of claim 10,
wherein the access attempt is made by the terminal in 5GS mobility management (5GMM)-IDLE mode, or 5GMM-CONNECTED mode with radio resource control (RRC) inactive indication.

12. The terminal of claim 10,
wherein in case that the terminal is attempt to access emergency service, the at least one information on the network slice related to the access attempt is not transmitted to the lower layer of the terminal.

13. The terminal of claim 10,
wherein the message for the PDU session comprises at least one of a message for PDU session modification, a message for PDU session establishment, or a message for PDU session release.

14. The terminal of claim 10, wherein the at least one processor further configured to:
based on the at least one information of the network slice related to the access attempt, use resources for the network slice
